(19) United States
(12) Patent Application Publication
(10) Pub. No.: US 2004/0188945 A1
(43) Pub. Date: Sep. 30, 2004

(54) Sealing device

(76) Inventors: Michel Poincet, Colombes (FR); Philippe Roberge, Issy Les Moulineaux (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/487,055

(22) PCT Filed: Sep. 13, 2002
(86) PCT No.: PCT/FR02/03131

(30) Foreign Application Priority Data
Sep. 14, 2001 (FR) 01/11939

(51) Int. Cl. F16J 15/34

(52) U.S. Cl. 277/408

(57) ABSTRACT

The invention relates to a device to seal a cavity formed between a part moving in rotation and a fixed part. The invention is particularly useful for angle of incidence measuring probes used in aeronautics.

The device comprises a cavity (8) formed between the moving part (2, 4) and the fixed part (6). A seal (11) ensures the sealing of the cavity (8). The seal (11) is produced by means of a fluid located between the fixed part (6) and the moving part (2, 4). The device furthermore comprises means (24) for balancing the air pressure between the inside of the cavity (8) and the outside.

The invention relates to a device to seal a cavity formed between a part moving in rotation and a fixed part. The invention is particularly useful for angle of incidence measuring probes used in aeronautics. Such probes comprise a vane that moves in rotation about an axis and is designed such that it becomes orientated in alignment with the direction of the airflow surrounding an aircraft upon with the probe is mounted. The measurement of airflow angle of incidence is an essential parameter for the piloting of the aircraft. It makes it possible to define the direction of the speed vector of the aircraft with respect to the ambient air which surrounds it.

The use of a mobile vane presents the problem of sealing the vane with respect to the skin of the aircraft. It is necessary to provide means to prevent liquid or solid particles from penetrating inside the aircraft. The installation of the probe at various places on the skin of the aircraft can be envisaged. For example, in order to measure the sideslip of the aircraft, the probe is best placed in the vertical plane of symmetry of the aircraft, either in the “six o' clock” position, that is to say underneath the aircraft, or in the “twelve o' clock” position, that is to say on top of the aircraft. The six o' clock position of the probe increases the risk of shocks affecting the mobile vane, particularly during maintenance operations on the aircraft when it is on the ground. The twelve o' clock position of the probe makes it possible to minimize these risks but, on the other hand, it increase the problems related to sealing. In fact, at the connection between the mobile part and the fixed part, the risks of infiltration of particles by gravity increase, for example during the cleaning of the aircraft where the fluids used can more easily infiltrate between the moving part and the fixed part when the probe is in the twelve o' clock position than when the probe is in the six o' clock position.

It is of course understood that the invention is not limited to a probe in the twelve o' clock position nor even to an angle of incidence measuring probe. The invention can be used to provide the sealing of a cavity formed between a part moving in rotation and a fixed part. However, in order to give a better understanding of the problem raised and of the solution provided by the invention, the following description will be limited to the application of the invention to an angle of incidence measuring probe.

It is known to ensure the sealing of a probe by reducing to the minimum the clearance necessary for the free rotation of the vane with respect to the skin of the aircraft. It is even possible to provide a chicane complicating the routing of particles penetrating to the inside of the aircraft. These devices are still imperfect because the infiltration of particles is still possible.

Another solution consists in using a lip seal to provide the sealing. The body of the seal is then integral with one of the parts, for example with the fixed part, and the lip of the seal permanently rubs against the other part, in this case the mobile part. Besides the problems of wear of the lip of the seal, this solution generates friction which, in the case of a probe, is to the detriment of good angular measurement. More precisely, the use of a lip seal generates dry friction. The particular feature of this so-called “dry” friction is the necessity of applying a non-zero effort to the mobile part in order to move it with respect to the fixed part no matter what its speed of rotation may be. For an angle of incidence measuring probe, this non-zero effort gives rise to errors in the angle of incidence measurement.

The objective of the invention is to overcome these various disadvantages by proposing a sealed device without dry friction.

To achieve this objective, the invention relates to a sealing device between a part that is moving in rotation about an axis and a fixed part, the device comprising a cavity formed between the moving part and the fixed part, a seal ensuring the sealing of the cavity, characterized in that the seal is produced by means of a fluid located between the fixed part and the moving part, and in that the device comprises means for balancing the air pressure between the inside of the cavity and the outside.

The invention will be better understood and other advantages will become apparent on reading the detailed description of an embodiment of the invention, this description being illustrated by the appended drawing in which:

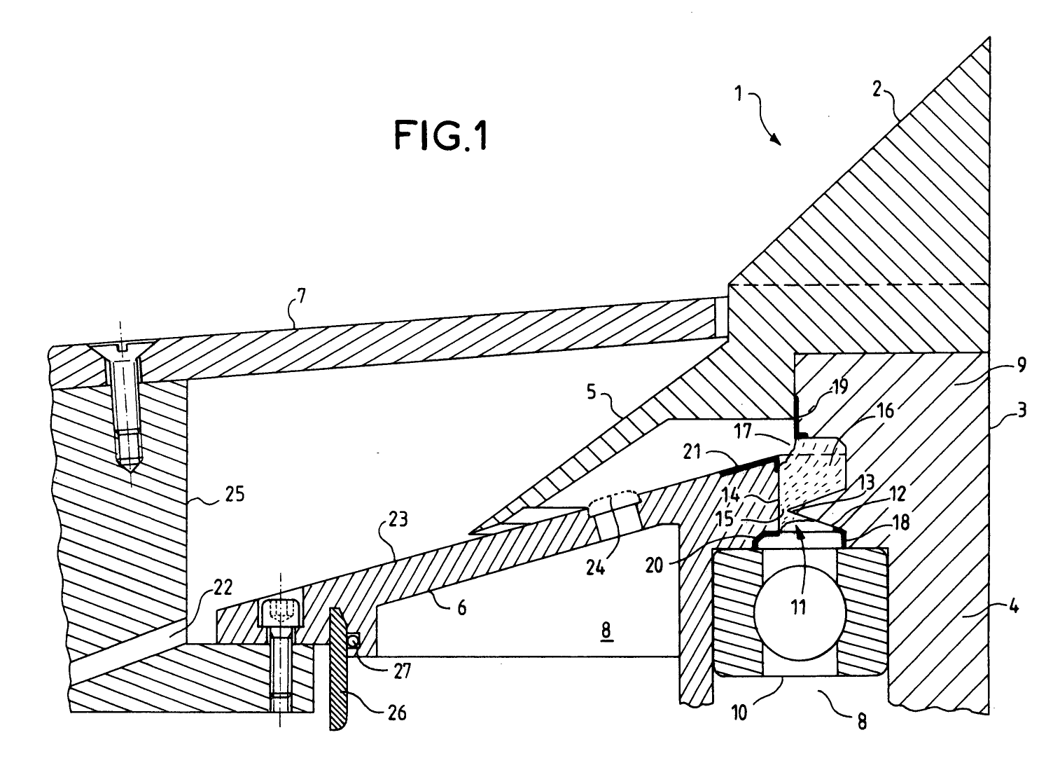

FIG. 1 shows, in partial cross-section, the sealing device of an angle of incidence measuring probe mounted on the skin of an aircraft.

The probe 1 shown in FIG. 1 comprises a vane 2 that moves in rotation about an axis 3 also serving as a delimitation for the partial cross-section forming FIG. 1. The vane 2 is integral with a shaft 4 having a shape of revolution about the axis 3. At its base, the vane 2 comprises a base 5 that is also integral with the shaft 4. The vane 2, its base 5 and the shaft 4 form a part that moves in rotation about the axis 3 with respect to a fixed part that is, in this case, formed by a casing 6 that is part of the probe 1. The casing 6 is integral with the skin 7 of an aircraft, possibly by the intermediary of a probe support 25. A cavity 8 is formed inside the casing 6. The cavity 8 is closed by the shaft 4 and, more particularly, by its upper part 9. The cavity 8 houses, for example, a sensor, not shown in the figure, measuring the angular displacement of the vane 2 about the axis 3 with respect to the casing 6. A bearing 10 located in the cavity 8 allows the rotation of the shaft 4 with respect to the casing 6. Furthermore, it is possible to provide complete sealing of the cavity 8 with respect to the inside of the aircraft by means of a cover 26 integral with the casing 6. The cover 26 can however be traversed by a sealed connector to allow information relating to the angular displacement measured by the probe 1 to pass through. It is possible to fit an “O” ring 27 located at the connection between the cover 26 and the casing 6.

A seal 11 seals the cavity 8 with respect to particles located outside of the cavity 8 and capable of penetrating into it. The seal 11 is formed by means of a fluid such as, for example, an oil and is located between the shaft 4 and the casing 6. More precisely, the shaft 4 comprises a lip 12. Between one end 13 of the lip 12 and a wall 14 of the casing 6 there remains a space 15 in which the fluid seal 11 is retained by capillarity. A reservoir 16 formed in the upper part 9 of the shaft 4 also contains fluid. The reservoir 16 is connected with the seal 11 and makes it possible to supply the space 15 with fluid in order to maintain fluid there permanently even when the fluid is slightly reabsorbed, for example by evaporation.

The reservoir 16 has an orifice 17 located between the upper part 9 of the shaft 4 and the casing 6. The orifice 17 makes it possible to fill the reservoir 16 or to top it up, for example by means of a syringe. Advantageously, the orifice 17 is accessible from outside of the device, for example, in the embodiment described here, on removing the vane 2.

For the fluid, it is possible to choose a silicone oil such as for example a “Versilube” oil manufactured by the General Electric company domiciled in the United States of America. From among the “Versilube” oils, it will be possible to choose a type F44 or F50. This type of oil has a wide operating temperature range (from −50° C. to +150° C.) and retains low viscosity over the whole of the temperature range. This type of oil has a long service life, evaporates little and does not oxidize significantly, even at high temperature. Furthermore, this type of oil is very stable in the presence of fluids currently used in aeronautics for cleaning or deicing aircraft.

Advantageously, in order to prevent the fluid from escaping from the zone containing it, that is to say the fluid seal 11 and the reservoir 16, the latter is delimited by a treatment of the mechanical parts containing the fluid using a produce repelling the fluid. When the fluid is an oil, an oil-repellent product will be used for example. By way of example, it will be possible to use a product from the “Fluorad” family marketed by the 3M company domiciled in the United States of America. This produce bears the reference FC-722.

According to the configuration shown in FIG. 1, the shaft 4 is treated with the oil-repellent product at the base 18 of the lip 12 and at the top 19 of the upper part 9 of the shaft 4 outside of the reservoir 16. Similarly, the casing 6 will be treated on surfaces 20 and 21 contiguous to the wall 14. The various treated surfaces are indicated by heavy line in FIG. 1.

The fluid seal 11 has a radial shape about the axis 3. More precisely, the walls of the parts delimiting the zone containing the fluid are surfaces of revolution about the axis 3.

The configuration described above in which the moving part is disposed inside the fixed part and in which the reservoir 16 is located in the moving part allows the fluid seal 11 to be maintained constantly bearing against the fixed part, in this instance against the wall 14 of the casing 6. More precisely, a movement of rotation of the vane 2 drives the reservoir 16 in rotation, which tends to centrifuge the liquid present in it and thus to maintain the presence of fluid in the space 15 even during fast rotation of the vane 2 with respect to the casing 6. It is however possible to adopt a reverse configuration when, for example, the rotation of the moving part takes place at low speed.

Advantageously, the bearing 10 is located inside the cavity 8 and the seal 11 ensures the sealing of the bearing 10. More precisely, when the bearing 10 is located in the immediate vicinity of the seal 11 at the top of the cavity 8, no air flow can pass through the bearing 10. This configuration makes it possible to prevent any particle deposit inside the bearing 10. Such deposits would risk damaging the bearing 10. This configuration also makes it possible to use a bearing 10 without any particular means to provide its own sealing such as, for example, a flange which, in any case, would provide only imperfect sealing. Other means exist for ensuring the sealing of the bearing 10. These means comprise lip seals and must be prohibited because they generate dry friction.

Advantageously, the device comprises means ensuring the drainage of the particles stopped by the seal 11. For example, the casing 6 comprises a slope 23 which drives possible particles, stopped by the seal 11, by gravity towards an evacuation pipe 22 formed in the support 8.

Advantageously, the device furthermore comprises means for balancing the air pressure between inside the cavity 8 and the outside. This pressure balancing is useful in aeronautics where the pressure of the air located outside of the cavity can vary greatly. This pressure is of the order of 1 bar when the aircraft is standing on the ground and it can drop to 0.2 bar when the aircraft is at high altitude. In the absence of means for balancing the pressure, and if the cavity 8 were to remain at the ground-level atmospheric pressure, the seal 11 could become dislocated under the effect of too great a pressure difference. The means for balancing the air pressure comprise, for example, a filter 24 that is impermeable to liquid or solid particles. The filter 24 is located between the cavity 8 and a space connected to the ambient air surrounding the vane 2. In the example embodiment shown here, the filter 23 is located on the slope 23 of the casing 6.

It is therefore advantageous that the filter 24 should protrude with respect to the slope 23 or, more generally, with respect to the drainage means in order to prevent the filter 24 from being subjected to any obstruction by particles stopped by the seal 11. The filter 24 can comprise a grid whose pitch is sufficiently small to prevent the passage of solid particles. Furthermore, the filter is advantageously treated with a water-repellent product so that liquid particles do not remain static on the filter and risk obstructing it. As a water-repellent product, it will be possible for example to use the product bearing the reference FC-722 manufactured by the 3M company, already mentioned above as an oil-repellent product.

Advantageously, the device comprises means allowing the seal 11 to provide a viscous dampening function for the movement of rotation of the moving part with respect to the fixed part.

Such a damper, makes it possible to dampen the movements of the vane 2 in order that a fast change of orientation of the air flow in which the vane 2 is immersed does not give rise to an overshoot of the vane 2. The term “overshoot” means a movement of the vane 2 beyond its stabilized position after the fast change of orientation of the airflow. Furthermore, as in the case of the fluid seal 11, such a damper must not give rise to dry friction. In order to maintain a substantially constant damping factor, it is also necessary to maintain the viscosity of the fluid used for the fluid seal 11 constant. It is however known that the viscosity of a fluid is essentially dependent on its temperature. It will therefore be possible to provide a heater, for example in the form of an electrical resistive element, this heater being located in the reservoir 16 or in its immediate vicinity. The electrical power supply for the resistive element can be regulated in such a way as to maintain a substantially constant fluid temperature. For this purpose, it will be possible for example to use a resistive element having a positive temperature coefficient.

1. A sealing device between a part that is moving in rotation about an axis and a fixed part:
a cavity formed between the moving part and the fixed part compring,
a seal ensuring the sealing of the cavity, the seal is produced by means of a fluid located between the fixed part and the moving part, and means for balancing the air pressure between the inside of the cavity and the outside.

2. The device as claimed in claim 1, wherein the moving part comprises a vane designed to measure the angle of angle of incidence of an airflow with respect to the skin of an aircraft and a shaft integral with the vane, in that the fixed part comprises a casing integral with the skin of the aircraft, in that the cavity is formed inside the casing and is closed by the shaft, and in that the seal is located between the shaft and the casing.

3. The device as claimed in claim 1, wherein the sealing device comprises a fluid reservoir, the reservoir being connected with the seal.

4. The device as claimed in claim 1, wherein the fluid is confined in a zone delimited by a treatment of the metal parts containing the fluid by means of a product repelling the fluid.

5. The device as claimed in claim 1, wherein the sealing device comprises means for maintaining the seal bearing against the fixed part.

6. The device as claimed in claim 3, wherein the moving part is disposed inside of the fixed part and in that the fluid reservoir is located in the moving part.

7. The device as claimed in claim 1, wherein the sealing device comprises a bearing located inside the cavity and ensuring the rotation of the moving part with respect to the fixed part, and in that the seal ensures the sealing of the bearing.

8. The device as claimed in claim 1, wherein the sealing device comprises means ensuring the drainage of particles stopped by the seal.

9. The device as claimed in claim 1, wherein the means of balancing the air pressure comprise a filter that is impermeable to liquid or solid particles.

10. The device as claimed in claim 1, wherein the sealing device comprises means allowing the seal to provide the function of a viscous damper to the movement of rotation of the moving part with respect to the fixed part.

11. The device as claimed in claim 2, wherein the sealing device comprises a fluid reservoir, the reservoir being connected with the seal.

12. The device as claimed in claim 2, wherein the fluid is confined in a zone delimited by a treatment of the metal parts containing the fluid by means of a product repelling the fluid.

13. The device as claimed in claim 3, wherein the fluid is confined in a zone delimited by a treatment of the metal parts containing the fluid by means of a product repelling the fluid.

14. The device as claimed in claim 4, wherein the sealing device comprises means for maintaining the seal bearing against the fixed part.

15. The device as claimed in claim 2, wherein the sealing device comprises a bearing located inside the cavity and ensuring the rotation of the moving part with respect to the fixed part, and in that the seal ensures the sealing of the bearing.

16. The device as claimed in claim 3, wherein the sealing device comprises a bearing located inside the cavity and ensuring the rotation of the moving part with respect to the fixed part, and in that the seal ensures the sealing of the bearing.

17. The device as claimed in claim 6, wherein the sealing device comprises a bearing located inside the cavity and ensuring the rotation of the moving part with respect to the fixed part, and in that the seal ensures the sealing of the bearing.

18. The device as claimed in claim 7, wherein the sealing device comprises means ensuring the drainage of particles stopped by the seal.

19. The device as claimed in claim 2, wherein the means of balancing the air pressure comprise a filter that is impermeable to liquid or solid particles.

20. The device as claimed in claim 2, wherein the sealing device comprises means allowing the seal to provide the function of a viscous damper to the movement of rotation of the moving part with respect to the fixed part.
